(19) United States
(12) Patent Application Publication
(10) Pub. No.: US 2024/0416657 A1
(43) Pub. Date: Dec. 19, 2024

(54) INKJET RECORDING APPARATUS

(71) Applicant: KYOCERA Document Solutions Inc., Osaka (JP)

(72) Inventors: Yasutaka INUI, Osaka-shi (JP); Shuhei KAWAMATA, Osaka-shi (JP)

(73) Assignee: KYOCERA Document Solutions Inc., Osaka (JP)

(21) Appl. No.: 18/744,563

(22) Filed: Jun. 14, 2024

(30) Foreign Application Priority Data
Jun. 15, 2023 (JP) 2023-098247

(51) Int. Cl. B41J 2/165; B41J 25/304

(52) U.S. Cl. CPC B41J 2/16538; B41J 2/16508; B41J 2/16544; B41J 25/304

(57) ABSTRACT

An inkjet recording apparatus includes a blade and a receiving member. The blade slides in a predetermined traveling direction along a nozzle surface of an inkjet head in a state where a tip end portion is pressed against the nozzle surface. The receiving member is provided at a sliding end position of the blade and receiving a waste liquid discharged from the blade.

### INCORPORATION BY REFERENCE

This application is based on and claims the benefit of priority from Japanese patent application No. 2023-098247 filed on Jun. 15, 2023 which is incorporated by reference in its entirety.

### BACKGROUND

The present disclosure relates to an inkjet recording apparatus.

In the inkjet recording apparatus, it is considered that water evaporates from ink in a nozzle of an inkjet head during a period when an image forming job is not performed, and the nozzle is clogged due to an increase in a viscosity of the ink. To prevent the clogging, a purge treatment is performed in which the ink in the nozzle is ejected into a cap. However, if the remaining ink is left on a nozzle surface, there is a problem that the ink falls on a sheet during performing the image forming job or that the ink is stuck on the nozzle surface. Therefore, a technology for removing the ink remaining on the nozzle surface is discussed. For example, a configuration is proposed in which the ink is removed from the nozzle surface by sliding a blade in contact with the nozzle surface in a predetermined direction.

In the above configuration, the blade is bent when the blade is slid in contact with the nozzle surface, but when the bending of the blade is returned beyond the end of the nozzle surface at the end of the sliding, there is a problem that a waste liquid adhering to the blade is scattered around.

### SUMMARY

An inkjet recording apparatus according to the present disclosure includes a blade and a receiving member. The blade slides in a predetermined traveling direction along a nozzle surface of an inkjet head in a state where a tip end portion is pressed against the nozzle surface. The receiving member is provided at a sliding end position of the blade and receiving a waste liquid discharged from the blade.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inside of an inkjet recording apparatus according to one embodiment of the present disclosure.

FIG. 2 is a plan view showing an image forming unit according to the embodiment of the present disclosure.

FIG. 3 is a sectional view showing the image forming unit according to the embodiment of the present disclosure.

FIG. 4 is a view schematically showing an ink supply pass according to the embodiment of the present disclosure.

FIG. 5 is a sectional view showing an inkjet head according to the embodiment of the present disclosure.

FIG. 6 is a perspective view showing a maintenance device according to the embodiment of the present disclosure.

FIG. 7 is a perspective view showing a cap unit, which is moved rightward, according to the embodiment of the present disclosure.

FIG. 8 is a perspective view showing a cap unit and a wipe unit, which are moved rightward, according to the embodiment of the present disclosure.

FIG. 9 is a perspective view showing the wipe unit according to the embodiment of the present disclosure.

FIG. 10 is a perspective view showing the wipe unit according to the embodiment of the present disclosure.

FIG. 11 is a perspective view showing a blade unit according to the embodiment of the present disclosure.

FIG. 12 is a perspective view showing the blade unit according to the embodiment of the present disclosure.

FIG. 13 is a perspective view showing a protruding member according to the embodiment of the present disclosure.

FIG. 14 is a perspective view showing the protruding member according to the embodiment of the present disclosure.

FIG. 15 is a sectional view explaining an operation of the maintenance device and the head unit according to the embodiment of the present disclosure.

FIG. 16 is a sectional view explaining the operation of the maintenance device and the head unit according to the embodiment of the present disclosure.

FIG. 17 is a sectional view explaining the operation of the maintenance device and the head unit according to the embodiment of the present disclosure.

FIG. 18 is a sectional view explaining the operation of the maintenance device and the head unit according to the embodiment of the present disclosure.

FIG. 19 is a sectional view explaining the operation of the maintenance device and the head unit according to the embodiment of the present disclosure.

FIG. 20 is a sectional view explaining the operation of the maintenance device and the head unit according to the embodiment of the present disclosure.

FIG. 21 is a side view schematically explaining an operation of the blade unit according to the embodiment of the present disclosure.

FIG. 22 is a side view schematically explaining the operation of the blade unit according to the embodiment of the present disclosure.

FIG. 23 is a side view schematically explaining the operation of the blade unit according to the embodiment of the present disclosure.

FIG. 24 is a side view schematically explaining the operation of the blade unit according to the embodiment of the present disclosure.

FIG. 25 is a side view schematically explaining an operation of the blade unit according to the embodiment of the present disclosure.

FIG. 26 is a perspective view showing a receiving member according to the embodiment of the present disclosure.

FIG. 27 is a perspective view showing the receiving member according to the embodiment of the present disclosure.

FIG. 28 is a perspective view showing a fixing member, a blade and a holder according to the embodiment of the present disclosure.

### DETAILED DESCRIPTION

Hereinafter, with reference to the drawings, an inkjet recording apparatus according to one embodiment of the present disclosure will be described.

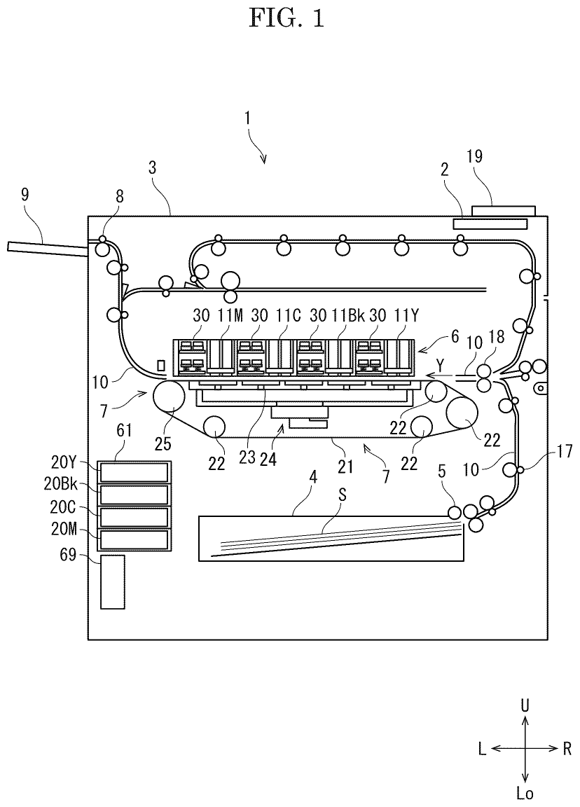

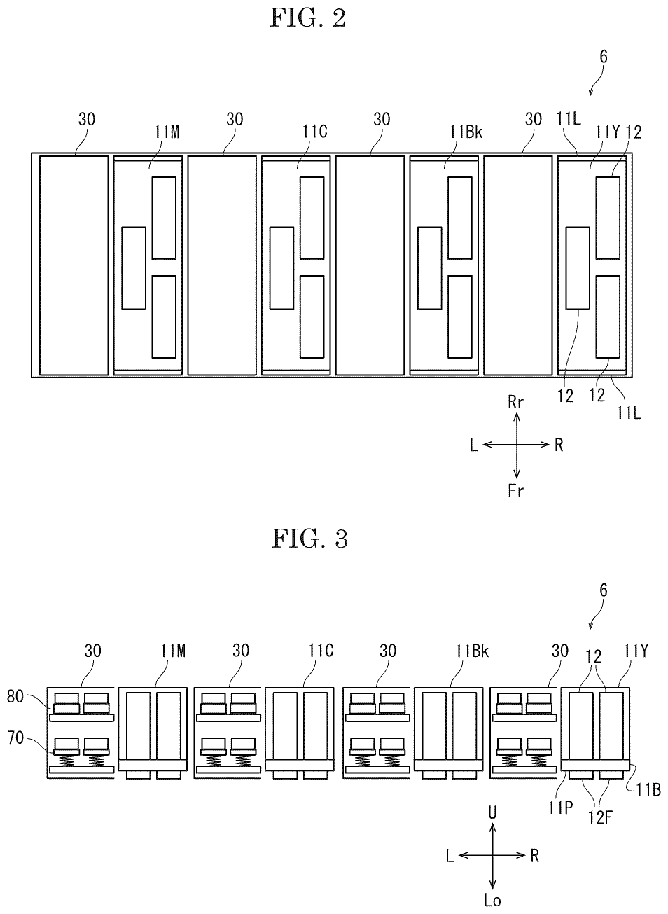

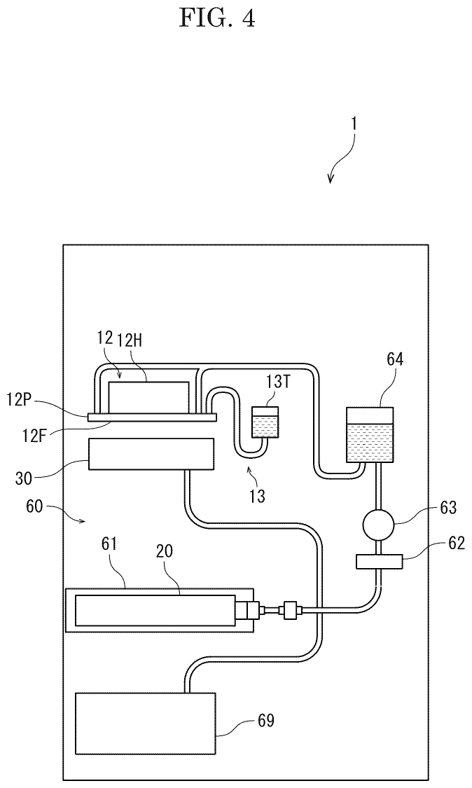

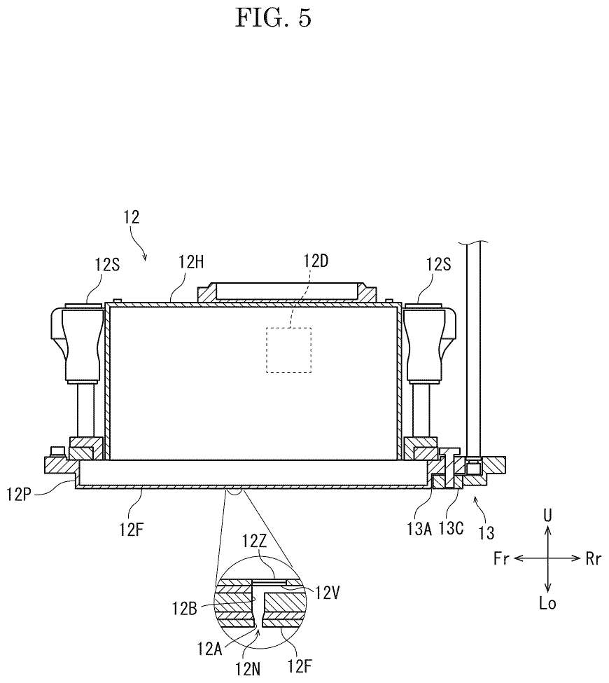

First, the entire configuration of the inkjet recording apparatus 1 will be described. FIG. 1 is a front view schematically showing the inside of the inkjet recording apparatus 1. FIG. 2 is a plan view showing an image forming unit 6. FIG. 3 is a sectional view showing the image forming unit 6. FIG. 4 is a view schematically showing an ink supply pass 60. FIG. 5 is a sectional view showing an inkjet head 12. Hereinafter, the front side of the paper plane on which FIG. 1 drawn is defined as the front side of the inkjet recording apparatus 1, and the left-and-right direction is described with reference to the direction in which the inkjet recording apparatus 1 is viewed from the front side. In each figure, U, Lo, L, R, Fr, and Rr indicates the upper, lower, left, right, front, and rear, respectively.

The inkjet recording apparatus 1 (see FIG. 1) includes a rectangular parallelepiped body housing 3. In the lower portion of the inside of the body housing 3, a sheet feeding cassette 4 in which a sheet S, such as a plain paper and a coated paper, is stored and a sheet feeding roller 5 which feeds the sheet S from the sheet feeding cassette 4 are provided. Above the sheet feeding cassette 4, a conveying unit 7 which attracts the sheet S and conveys it in the Y direction is provided. Above the conveying unit 7, an image forming unit 6 which forms an image by ejecting ink is provided. In the left and upper portion of the inside of the body housing 3, a discharge roller 8 which discharges the sheet S on which the image is formed and a discharge tray 9 on which the discharged sheet S is stacked are provided.

Inside the body housing 3, a conveyance path 10 from the sheet feeding roller 5 to the discharge roller 8 through a gap between the conveying unit 7 and the image forming unit 6 is provided. The conveyance path 10 is formed mainly of plate-like members facing each other with a gap through which the sheet S is passed. On the conveyance path 10, a conveyance roller 17 which conveys the sheet S while holding the sheet S is provided. A registration roller 18 is provided on the upstream side of the image forming unit 6 in the conveyance direction Y.

The conveying unit 7 includes an endless conveying belt 21, a support plate 23, and a suction part 24. The conveying belt 21 has a large number of air-holes (not shown), and is wound around a driving roller 25 and a driven roller 22. The support plate 23 has a large number of air-holes, and the upper surface is in contact with the inner surface of the conveying belt 21. The suction part 24 sucks air through the air-holes of the support plate 23 and the air-holes of the conveying belt 21 to attract the sheet S onto the conveying belt 21. When the driving roller 25 is driven in the counterclockwise direction by a driving part (not shown) including a motor and a reduction gear, the conveying belt 21 travels in the counterclockwise direction, and the sheet S attracted to the conveying belt 21 is conveyed in the Y direction.

The image forming unit 6 (see FIG. 2, FIG. 3) includes head units 11Y, 11Bk, 11C, and 11M (collectively referred to as the head unit 11). The head unit 11 includes one or more inkjet heads 12 (see FIG. 5), for example, three inkjet heads 12 arranged in a staggered pattern. Ink containers 20Y, 20Bk, 20C, and 20M (collectively referred to as the ink container 20) filled with the yellow, black, cyan, and magenta inks, respectively, are connected to the head units 11Y, 11Bk, 11C, and 11M via an ink supply pass 60 (see FIG. 4).

In FIG. 4, the ink supply pass 60 corresponding to one color ink is illustrated, but since the four colors of ink are used in this embodiment, the four ink supply passes 60 are actually provided. The inkjet recording apparatus 1 includes: a container attachment part 61 to which the ink container 20 is attached; a filter 62 which filters the ink; a pump 63 which sends the ink from the ink container 20 through the filter 62; a sub-tank 64 which stores the ink sent from the pump 63 and supplies the ink to the inkjet head 12; and a waste liquid tank 69 which stores a waste liquid discharged from a maintenance device 30. Although one inkjet head 12 is shown in FIG. 4, actually three inkjet heads 12 included in one head unit 11 are connected to one sub-tank 64.

The inkjet head 12 (see FIG. 5) includes a rectangular parallelepiped housing 12H whose longitudinal direction is along the front-and-rear direction, and a nozzle plate 12P provided at the bottom portion of the housing 12H. The nozzle plate 12P includes a large number of nozzles 12N arranged in the front-and-rear direction, and a socket 12S to which a pipe from the sub-tank 64 is connected. The nozzle 12N includes a branch flow pass 12B branched from the downstream side of the socket 12S, and an ejection port 12A provided on a nozzle surface 12F which is a lower surface of the nozzle plate 12P. A diaphragm 12V serves as a part of the inner wall of the branch flow pass 12B. The diaphragm 12V is provided with a pressurizing element 12Z. As the pressurizing element 12Z, a piezoelectric element, an electrostatic actuator, a heater, or the like is used. A driving circuit 12D for driving the pressurizing element 12Z is connected to the pressurizing element 12Z.

The inkjet head 12 is actually disposed above the sub-tank 64. The liquid surface in the sub-tank 64 is adjusted to be slightly lower than the nozzle surface 12F. Due to the head difference between the liquid surface and the nozzle surface 12F, a negative pressure acts on the ink in the nozzle 12N to form a meniscus in the nozzle 12N. After the ink is ejected from the inkjet head 12, the surface tension of the ink acts to reduce the surface area of the meniscus, and the resulting negative pressure draws the reduced amount of the ink from the sub-tank 64 to the inkjet head 12.

A control part 2 (see FIG. 1) includes an arithmetic part and a storage part (not shown). The arithmetic part is, for example, a CPU (Central Processing Unit). The storage part includes a storage medium such as ROM (Read Only Memory), RAM (Random Access Memory), EEPROM (Electrically Erasable Programmable Read Only Memory), and the like. The arithmetic part reads out the control program stored in the storage part and executes various processes. The control part 2 may be implemented by an integrated circuit that does not use software.

A display operation part 19 is provided on the upper portion of the body housing 3 (see FIG. 1). The display operation part 19 includes a display panel, a touch panel laminated on the display panel, and a keypad (not shown). The control part 2 displays a screen representing an operation menu, a status, or the like of the inkjet recording apparatus 1 on the display panel, and controls each part of the inkjet recording apparatus 1 in accordance with an operation detected by the touch panel and the keypad.

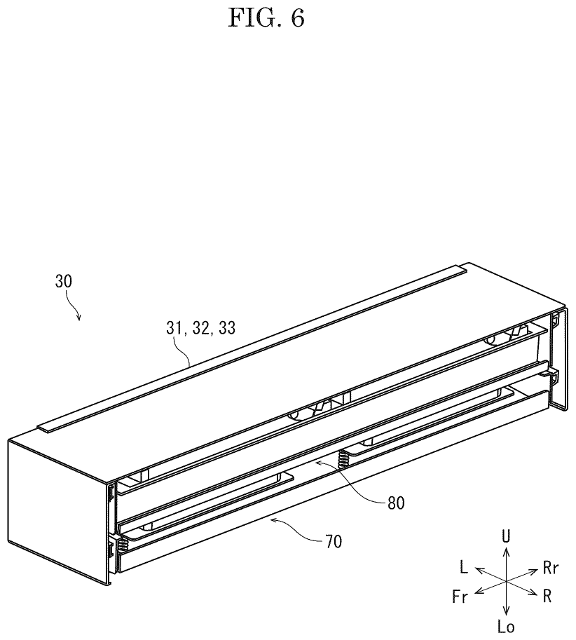

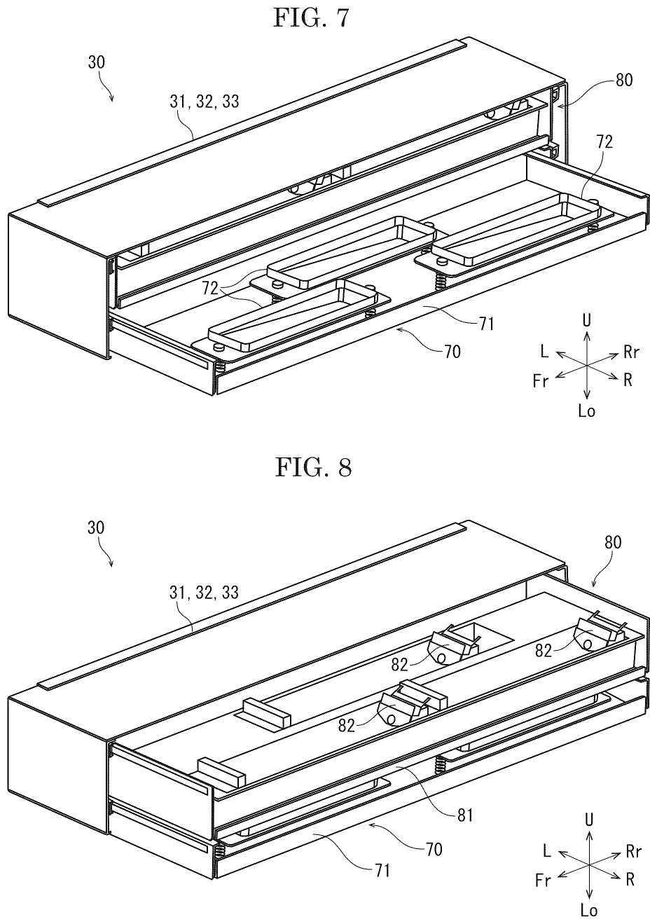

The basic image forming operation of the inkjet recording apparatus 1 is as follows. When an image forming job is inputted to the inkjet recording apparatus 1 from the display operation part 19 or an external computer, the sheet feeding roller 5 feeds the sheet S from the sheet feeding cassette 4 to the conveyance path 10, and the registration roller 18 whose rotation is stopped corrects the skew of the sheet S. When the registration roller 18 sends the sheet S to the conveying unit 7 at a predetermined timing, the conveying unit 7 attracts the sheet S to the conveying belt 21 and conveys the sheet S in the Y direction. The driving circuit 12D supplies an ejection signal corresponding to the image data to the pressurizing element 12Z in synchronization with the conveyance of the sheet S. Thus, the ink is ejected from the nozzle 12N, and an image is formed on the sheet S. The discharge roller 8 discharges the sheet S on which the image is formed to the discharge tray 9.

[Maintenance Device] Next, the configuration of the maintenance device 30 will be described. FIG. 6 is a perspective view showing the maintenance device 30. FIG. 7 is a perspective view showing a cap unit 70 which is slid rightward. FIG. 8 is a perspective view showing a wipe unit 80 and the cap unit 70 which are slid rightward.

The maintenance device 30 is provided for each head unit 11 on the left side adjacent to the corresponding head unit 11 (on the downstream side in the conveyance direction Y) (see FIG. 2, FIG. 3). The maintenance device 30 may be provided on the right side adjacent to the corresponding head unit 11 (on the upstream side in the conveyance direction Y).

The maintenance device 30 includes: a cap unit 70 provided with caps 72 mounted on the nozzle surface 12F; a wipe unit 80 provided with blades 82 which removes the ink remaining on the nozzle surface 12F; and a housing 31 in which the cap unit 70 and the wipe unit 80 are housed. The housing 31 is formed in a rectangular parallelepiped shape whose longitudinal direction is along the front-and-rear direction, and an opening is provided on the right side surface. The maintenance device 30 includes a cap sliding mechanism 32 which slides the cap unit 70 in the left-and-right direction, and a wipe sliding mechanism 33 which slides the wipe unit 80 in the left-and-right direction. The cap sliding mechanism 32 and the wipe sliding mechanism 33 includes, for example, a belt drive, a rack and pinion, a feed screw, and the like.

[Cap Unit] The cap unit 70 (see FIG. 7) includes a frame 71 and the caps 72 provided above the frame 71. The frame 71 is formed in a rectangular shape whose longitudinal direction is along the front-and-rear direction. On the frame 71, the same number of caps 72 as the inkjet heads 12 are arranged in a staggered pattern as with the inkjet heads 12. The cap 72 is opened upward. The cap 72 has a size surrounding an area provided with the nozzle 12N on the nozzle surface 12F of one inkjet head 12.

[Wipe Unit] The wipe unit 80 (see FIG. 8) includes a frame 81, a carriage 83 provided on the frame 81, blades 82 provided on the carriage 83, and a carriage sliding mechanism (not shown) which slides the carriage 83 in the front-and-rear direction. The frame 81 is formed in a rectangular shape whose longitudinal direction is along the front-and-rear direction. In the carriage 83, the same number of blades 82 as the inkjet heads 12 are arranged in a staggered pattern as with the inkjet heads 12. A pipe (not shown) connected to the waste liquid tank 69 is connected to the frame 81. The carriage sliding mechanism includes, for example, a belt drive, a rack and pinion, a feed screw, and the like.

[Lifting mechanism] The inkjet recording apparatus 1 includes a lifting mechanism 11L (see FIG. 2) which lifts and lowers the head unit 11. The lifting mechanism 11L includes, for example, a belt drive, a rack and pinion, a feed screw, and the like. The lifting mechanism 11L lifts and lowers the head unit 11 between an image forming position at which the image forming operation is performed and a retracted position higher than the image forming position. In the image forming position, the head unit 11 is positioned so that a distance between the conveying belt 21 and the nozzle surface 12F is a predetermined distance. In the retracted position, a space to which the cap unit 70 and the wipe unit 80 can be moved is formed between the conveying belt 21 and the nozzle surface 12F.

[Cleaning liquid Supply Part] The inkjet head 12 is provided with a cleaning liquid supply part 13 (see FIG. 4, FIG. 5) which supplies cleaning liquid to the nozzle surface 12F. The cleaning liquid supply part 13 includes a cleaning liquid tank 13T and a connection member 13C. The cleaning liquid tank 13T stores the cleaning liquid mainly consisting of water. The connection member 13C is provided on the rear side of the nozzle plate 12P. A pipe from the cleaning liquid tank 13T is connected to the connection member 13C. On the bottom portion of the connection member 13C, a cleaning liquid supply port 13A is provided. The liquid surface in the cleaning liquid tank 13T is adjusted to be slightly higher than the bottom surface of the connection member 13C. A positive pressure is generated in the cleaning liquid supply port 13A, and a convex meniscus expanding downward is formed.

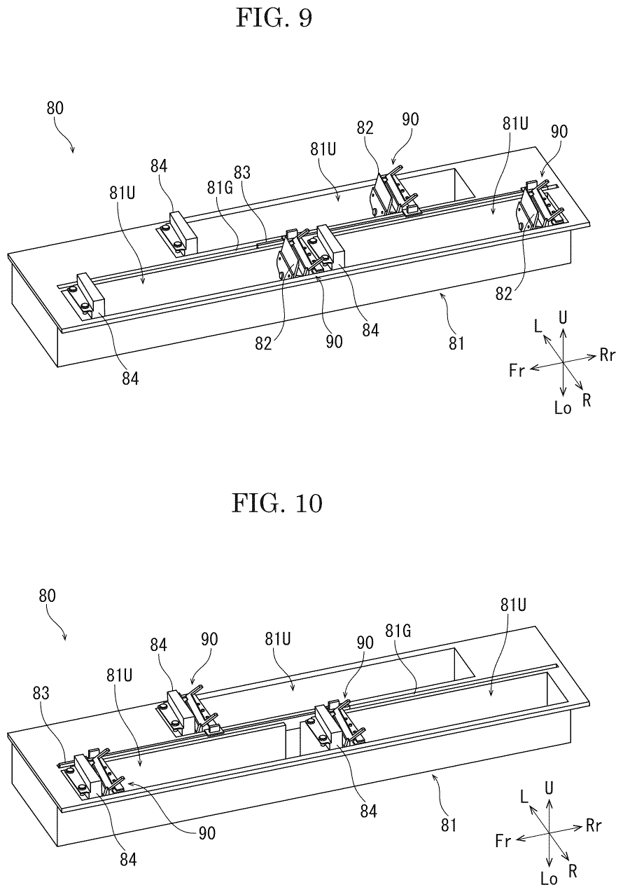

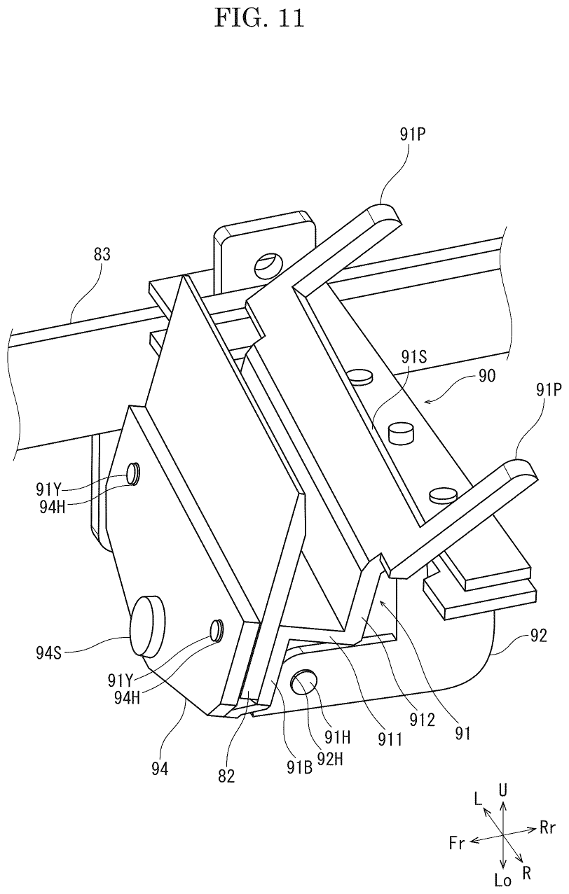

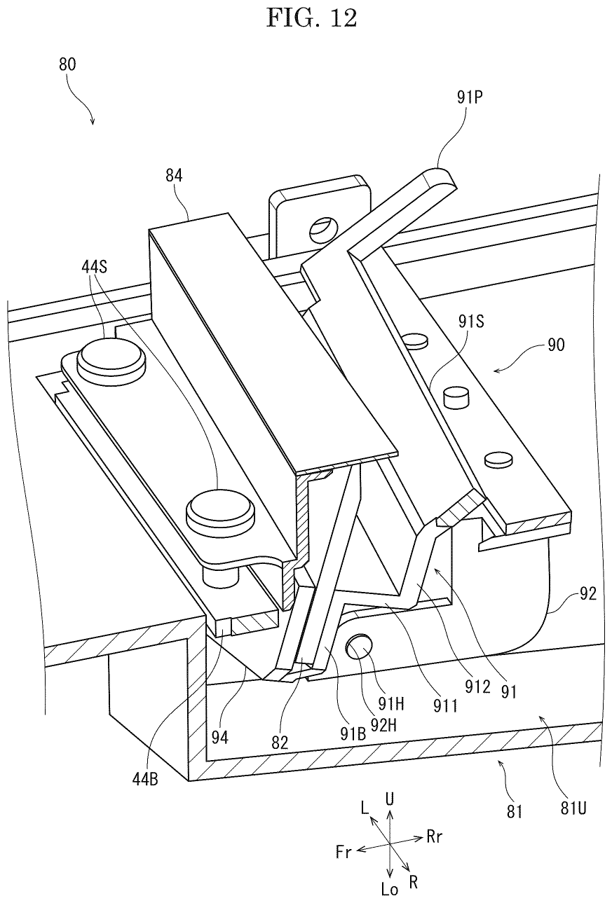

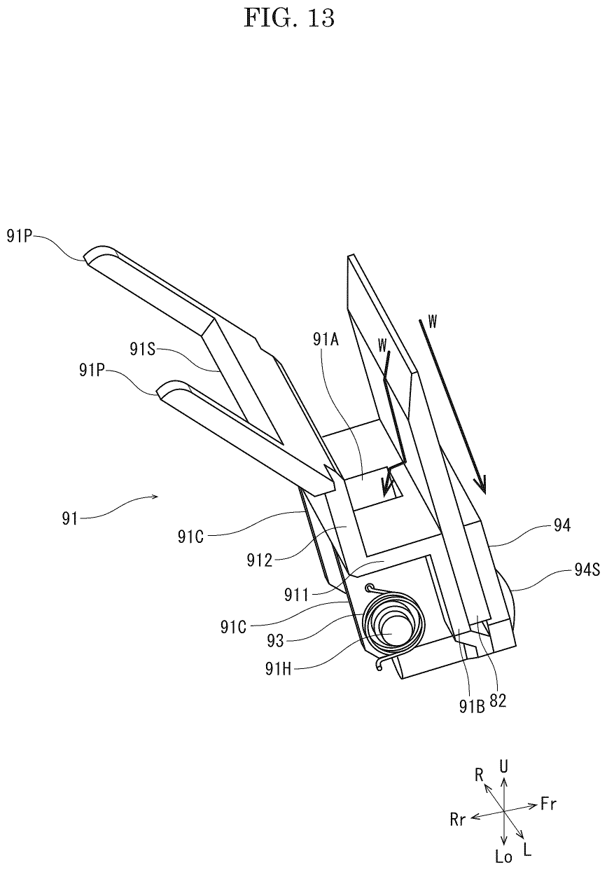

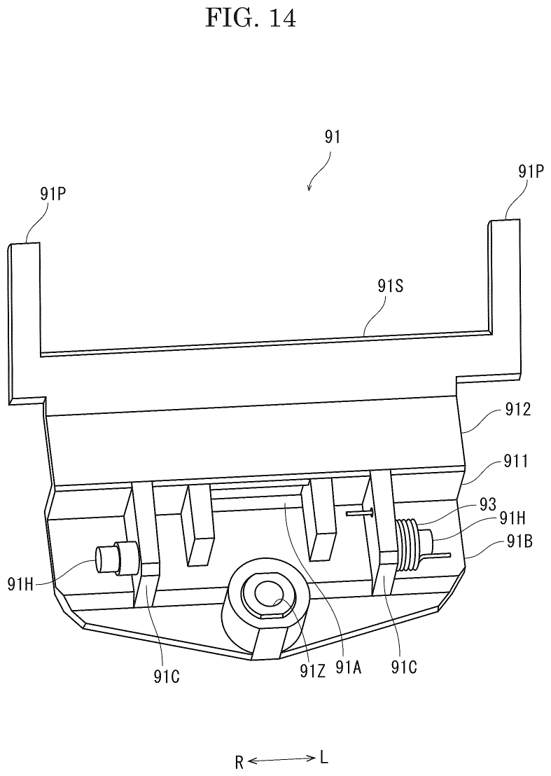

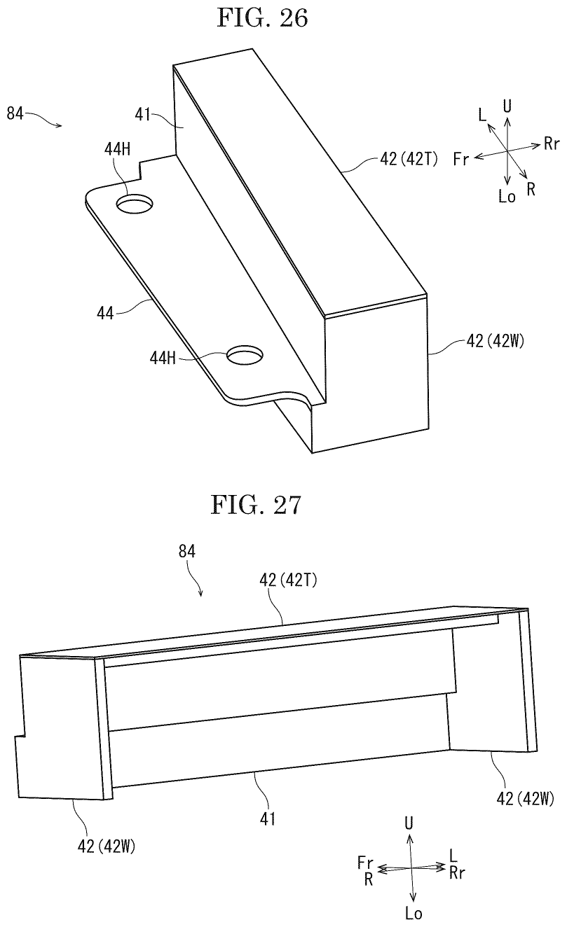

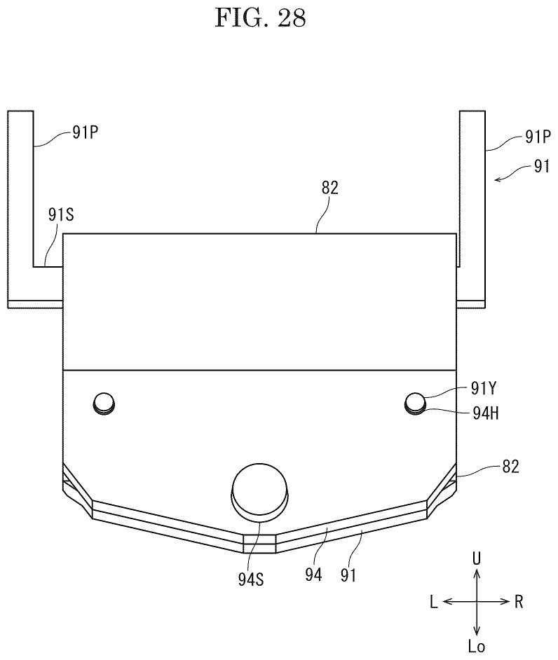

Next, the wipe unit 80 will be described in detail. FIG. 9 and FIG. 10 are perspective views showing the wipe unit 80. FIG. 11 is a perspective view showing a blade unit 90. FIG. 12 is a perspective view showing a cross section of the wipe unit 80. FIG. 13 is a perspective view showing a protruding member 91 and a blade 82. FIG. 14 is a perspective view showing the protruding member 91. FIG. 26 and FIG. 27 are perspective views showing a receiving member 84. FIG. 28 is a perspective view showing a fixing member 94, the blade 82, and a holder 92.

The inkjet recording apparatus 1 according to the present embodiment is provided with a blade 82 sliding in a predetermined traveling direction D along the nozzle surface 12F in a state where the tip portion is pressed against the nozzle surface 12F of the inkjet head 12, and a receiving member 84 provided at a sliding end position of the blade 82 and receiving the waste liquid W discharged from the blade 82. Specifically, they are as follows.

The wipe unit 80 (see FIG. 9, FIG. 10) includes a plurality of (in this embodiment, three) blade units 90, the frame 81, and the carriage 83. The blade unit 90 (see FIG. 11, FIG. 12) includes the blade 82, a protruding member 91, a holder 92, and a biasing member 93.

[Blade] The blade 82 (see FIG. 11 to FIG. 13) is a flexible rectangular plate-like member made of resin or the like. The blade 82 is held by the holder 92 in a slightly rearward inclined posture whose thickness direction is along the front-and-rear direction. The width of the blade 82 in the left-and-right direction is equal to or larger than the width of the region where the nozzle 12N is provided on the nozzle surface 12F. The upper portion of the blade 82 is formed to be tapered so that the thickness becomes thinner as it is closer to the upper end.

[Protruding Member] The protruding member 91 (see FIG. 11 to FIG. 14) is integrated with the blade 82. The protruding member 91 has: a base portion 91B parallel to the blade 82; a first bent portion 911 bent rearward from the upper end portion of the base portion 91B; a second bent portion 912 bent upward from the rear end portion of the first bent portion 911; a rear inclined portion 91S bent more rearward than the second bent portion 912; and a protruding portion 91P protruding upward from the upper end portion of the rear inclined portion 91S. The width of the base portion 91B in the left-and-right direction is equal to the width of the blade 82. The length of the base portion 91B in the upper-and-lower direction is about ½ of the length of the blade 82. The base portion 91B is joined to the lower portion of the rear surface of the blade 82. The base portion 91B is provided with shafts 91H whose axial direction is along the left-and-right direction (see FIG. 13, FIG. 14). The width of the first bent portion 911 and the second bent portion 912 in the left-and-right direction is equal to the width of the base portion 91B.

The width of the rear inclined portion 91S in the left-and-right direction is wider than the width of the blade 82. The protruding portion 91P is provided at both the left and right end portions of the upper end of the rear inclined portion 91S. The protruding portion 91P is provided on the outside of the blade 82 in the left-and-right direction. In other words, the protruding portion 91P is provided on the outside of the region where the nozzle 12N is provided on the nozzle surface N, in the left-and-right direction. The protruding portion 91P is inclined rearward at an inclination angle equal to that of the rear inclined portion 91S. A through-hole 91A penetrating downward is provided in the center portion of the first bent portion 911 in the left-and-right direction. At least a part of the waste liquid W (a mixture of the ink i and the cleaning liquid F) flowing down along the rear surface of the blade 82 is discharged downward through the through-hole 91A.

[Fixing Member] The fixing member 94 (see FIG. 11, FIG. 28) fixes the blade 82 to the protruding member 91. The blade 82 is disposed on the front side of the protruding member 91, and the fixing member 94 is disposed on the front side of the blade 82. The lower portion of the blade 82 is held between the base portion 91B of the protruding member 91 and the fixing member 94. On the front surface of the base portion 91B of the protruding member 91, left and right bosses 91Y protruding forward are provided. The blade 82 is provided with boss holes (not shown) into which the bosses 91Y are fitted. The fixing member 94 is also provided with boss holes 94H into which the bosses 91Y are fitted. A screw hole 91Z (see FIG. 14) is provided at the lower portion of the protruding member 91 below the blade 82. The fixing member 94 is also provided with a screw hole (not shown) corresponding to the screw hole 91Z. The blade 82 and the fixing member 94 are fitted to the bosses 91Y, and the fixing member 94 is fastened to the protruding member 91 using a screw 94S. As the result, the blade 82 is fixed to the protruding member 91.

The lower edge portion of the fixing member 94 and the lower edge portion of the protruding member 91 are formed to be tapered (see FIG. 28) so that the width in the left-and-right direction becomes narrower downward. The waste liquid flowing down from the front surface of the blade 82 to the front surface of the fixing member 94 is collected in the center in the-left and-right direction along the lower edge portion of the fixing member 94 and the lower edge portion of the protruding member 91, and falls into the recess 81U of the frame 81.

[Holder] The holder 92 (see FIG. 11, FIG. 12) holds the blade 82 through the protruding member 91. Holes 92H into which the shafts 91H of the protruding member 91 are inserted are provided at the lower portion of the holder 92 (see FIG. 11, FIG. 12). On the rear surface (see FIG. 13, FIG. 14) of the base portion 91B, two wall portions 91C facing each other in the left-and-right direction are provided. The shaft 91H protruding leftward is provided on the left surface of the left wall portion 91C. The shaft 91H protruding rightward is provided on the right surface of the right wall portion 91C. The protruding member 91 is hinge-connected to the holder 92, and the protruding member 91 can be swung in the front-and-rear direction with respect to the holder 92. The blade 82 is swung together with the protruding member 91. The shafts 91H may be provided on the blade 82.

The blade 82 and the protruding member 91 are provided on the holder 92 in an inclined posture with respect to the left-and-right direction so that the waste liquid W flows in one of the left and right directions. In the illustrated example, the blade 82 is inclined such that the left end portion is positioned on the slightly rear side of the right end portion, but may be inclined in the opposite direction.

[Biasing Member] The biasing member 93 (see FIG. 13, FIG. 14) is, for example, a torsional coil spring, and is wound around the shaft 91H. One end portion of the biasing member 93 is engaged with the holder 92, and the other end portion is engaged with the protruding member 91. The biasing member 93 biases the protruding member 91 in the counterclockwise direction in FIG. 11 and FIG. 12 and in the clockwise direction in FIG. 13. In other words, the biasing member 93 biases the blade 82 in the direction in which the tip portion of the blade 82 is pressed against the nozzle surface 12F. The biasing member 93 may be a leaf spring, a compression coil spring, or the like.

[Frame] The frame 81 (see FIG. 9, FIG. 10) is generally formed in a rectangular parallelepiped shape whose longitudinal direction is along the front-and-rear direction. The frame 81 includes three recesses 81U with an upper surface opened. The three recesses 81U face the three inkjet heads 12 provided in the head unit 11. That is, the three recesses 81U include two recesses 81U arranged along the front-and-rear direction and one recess 81U arranged staggered on the left side of the two recesses 81U. The recess 81U is formed in a rectangular shape elongated in the front-and-rear direction when viewed from the upper side. The length of the recess 81U in the front-and-rear direction is slightly longer than that of the nozzle surface 12F, and the width of the recess 81U in the left-and-right direction is slightly wider than that of the nozzle surface 12F. The recess 81U also serves as a receptacle for receiving the waste liquid containing the ink and the cleaning liquid.

[Carriage] The carriage 83 (see FIG. 9 to FIG. 12) is formed in a plate-like shape whose longitudinal direction is along the front-and-rear direction. A groove 81G along the front-and-rear direction is provided between the left and right recesses 81U, and the carriage 83 is housed in the groove 81G. The length of the carriage 83 in the front-and-rear direction is shorter than the length of the groove 81G in the front-and-rear direction. Accordingly, the carriage 83 can be slid in the front-and-rear direction along the groove 81G.

Each of the three recesses 81U houses one blade unit 90. The three blade units 90 are coupled to the carriage 83. The three blade units 90 are arranged so as to be positioned on the rear side of the nozzle surface 12F when the carriage 83 is positioned at the rearmost position.

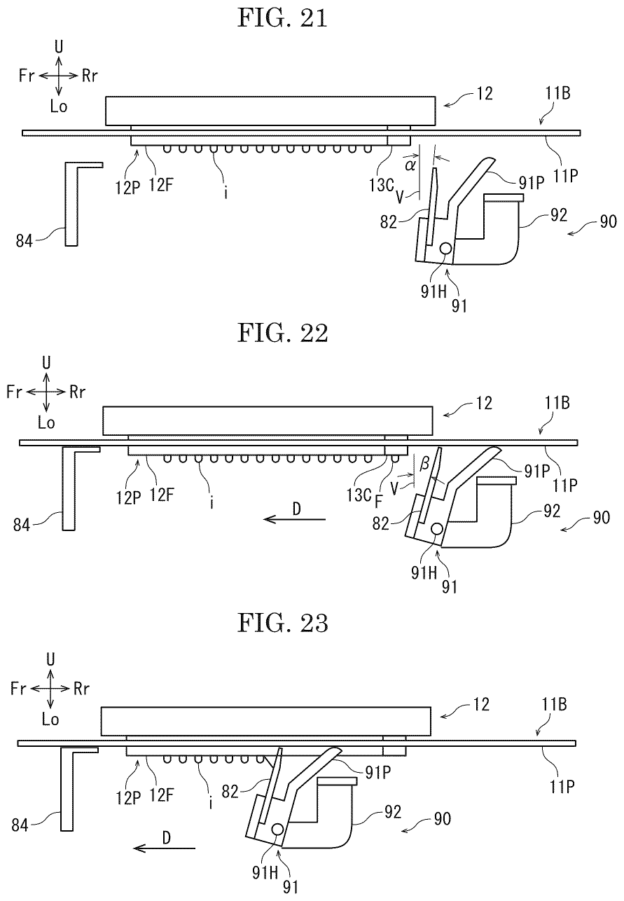

The frame 81 is provided with a driving part (not shown). The driving part is, for example, a belt drive, a rack and pinion, a feed screw, or the like, and slides the carriage 83 along the groove 81G in the front-and-rear direction. The carriage 83, the groove 81G, and the driving part constitute the carriage sliding mechanism described above.

[Receiving Member] The receiving member 84 (see FIG. 9, FIG. 10, FIG. 12, FIG. 21 to FIG. 27) is supported by the frame 81. The receiving member 84 is provided in each of the three recesses 81U. The receiving member 84 is provided at the front end portion of the recess 81U, in other words, at a sliding end position of the blade 82. The receiving member 84 includes a front part 41 facing the blade 82 on the front side in the traveling direction. The receiving member 84 includes a surrounding part 42 which surrounds the lateral surfaces and the upper surface of the blade 82 positioned at the sliding end position.

The surrounding part 42 includes a ceiling portion 42T provided rearward from the upper end portion of the front part 41, and lateral wall portions 42W provided rearward from both the left and right end portions of the front part 41. That is, the receiving member 84 is formed in a box shape with the rear side and the lower side open. When the blade 82 reaches the frontmost end of the recess 81U, the blade 82 is accommodated in the receiving member 84. At this time, the blade 82 is surrounded by the receiving member 84 from the front, upper, left and right lateral sides. The surrounding part 42 may have either the ceiling portion 42T or the lateral wall portions 42W. That is, the surrounding part 42 surrounds at least one of the upper side and the lateral sides of the blade 82 positioned at the sliding end position.

On the front surface of the front part 41, a fixing portion 44 protruding forward is provided. The fixing portion 44 is a plate-like portion whose thickness direction is along the upper-and-lower direction. The fixing portion 44 has screw holes 44H penetrating in the upper-and-lower direction. The fixing portion 44 is fastened to a bracket 44B protruding rearward from the front end of the recess 81U using screws 44S (see FIG. 12).

Next, the operation of the maintenance device 30 will be described. FIG. 15 to FIG. 20 are sectional views explaining the operation of the maintenance device 30 and the head unit 11. FIG. 21 to FIG. 25 are side views schematically showing the operation of the blade unit 90.

A parallel surface 11P will now be described. The inkjet head 12 is supported by a head base 11B (see FIG. 21). The head base 11B has a through-hole (not shown) into which the nozzle plate 12P of the inkjet head 12 is inserted. Since the lower surface of the head base 11B is parallel to the nozzle surface 12F, it is called the parallel surface 11P. When the nozzle plate 12P is inserted into the head base 11B, the nozzle surface 12F protrudes downward from the parallel surface 11P by a few millimeters, and a step is formed between the parallel surface 11P and the nozzle surface 12F. The parallel surface 11P may be different from the present embodiment except that it is parallel to the nozzle surface 12F. For example, the parallel surface 11P and the nozzle surface 12F may be at the same height. Alternatively, the parallel surface 11P may be a portion of the nozzle surface 12F, that is, be a surface on the left and right sides of the region where the nozzle 12N is formed on the nozzle surface 12F.

Hereinafter, a state in which the head unit 11 is positioned at the image forming position (see FIG. 15) will be described as an initial state. In the initial state, the cap unit 70 and the wipe unit 80 are positioned at the home position. The home position is inside the housing 31, and is on the lateral side of the head unit 11 positioned at the image forming position. The operation shown below is executed by the control part 2 controlling the lifting mechanism 11L, the cap sliding mechanism 32, the wipe sliding mechanism 33, and the carriage sliding mechanism.

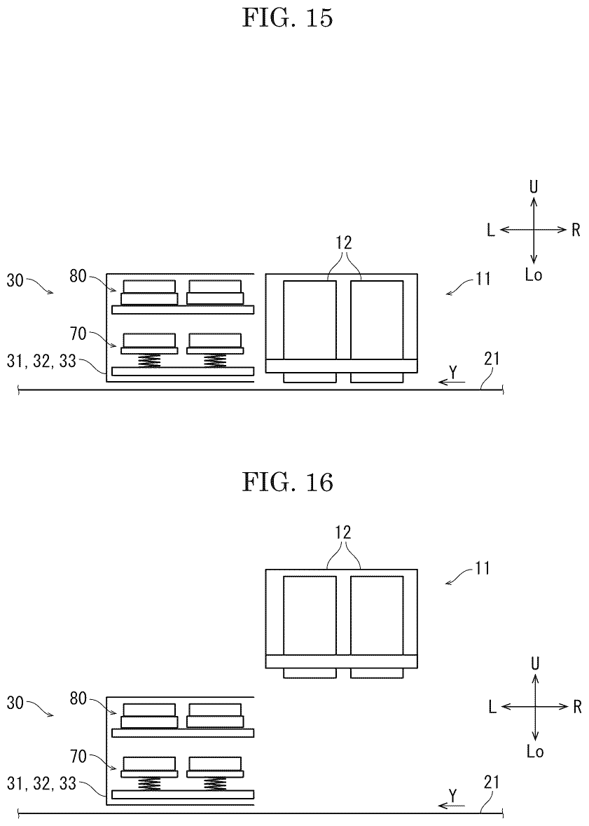

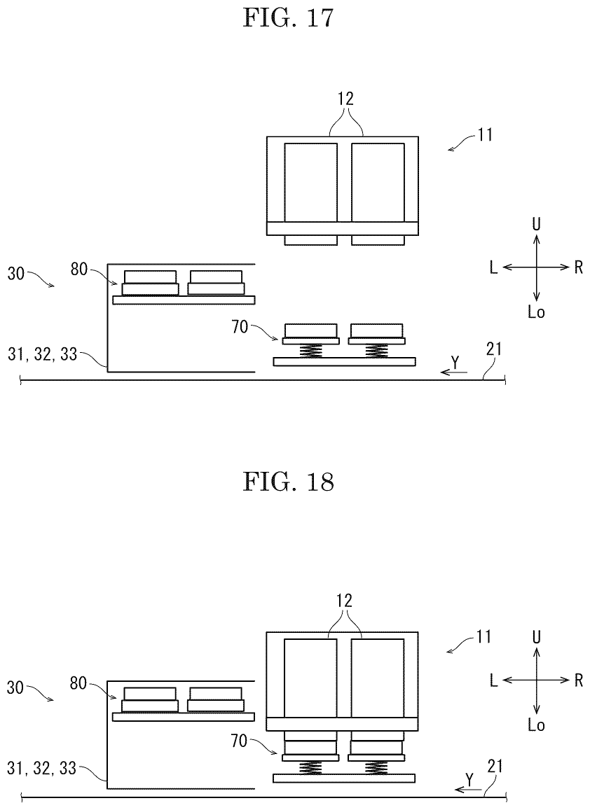

First, the control part 2 operates the lifting mechanism 11L to lift the head unit 11 to the retracted position (see FIG. 16). Next, the control part 2 operates the cap sliding mechanism 32 to slide the cap unit 70 below the head unit 11 (the maintenance position) (see FIG. 17). Next, the control part 2 operates the lifting mechanism 11L to lower the head unit 11 to a height where the nozzle surface 12F is in contact with the cap 72 (see FIG. 18). Next, the control part 2 controls the inkjet head 12 to purge the ink into the cap 72.

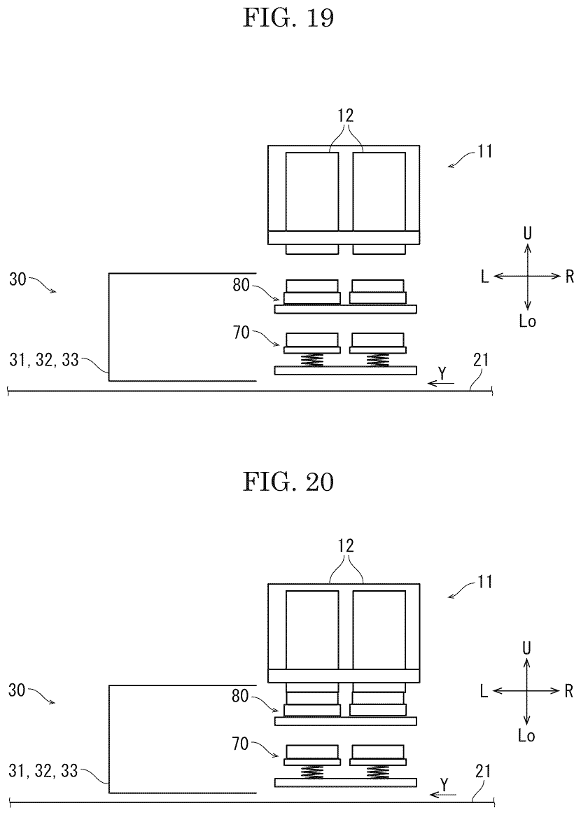

Next, the control part 2 operates the lifting mechanism 11L to lift the head unit 11 to the retracted position (see FIG. 17). Next, the control part 2 operates the wipe sliding mechanism 33 to slide the wipe unit 80 below the head unit 11 (the maintenance position) (see FIG. 19). At this time, in the wipe unit 80, the blade unit 90 is positioned at the rearmost position (see FIG. 21). The blade 82 has a posture inclined rearward by an angle α with respect to the vertical direction (the line segment V). The angle α is, for example, about 5 degrees. The ink i remains on the nozzle surface 12F.

Next, the control part 2 operates the lifting mechanism 11L to lower the head unit 11 to a predetermined position (see FIG. 20). In the predetermined position (see FIG. 22), the parallel surface 11P pushes the protruding portion 91P downward, causing the protruding member 91 and the blade 82 to swing in the clockwise direction and the blade 82 to be inclined rearward further. At this time, the blade 82 is inclined rearward by an angle β (α<β) with respect to the vertical direction. The angle β is, for example, about 15 degrees.

Next, the control part 2 operates the cleaning liquid supply part 13 to bulge the cleaning liquid F from the cleaning liquid supply port 13A of the connection member 13C (see FIG. 5, FIG. 22), and operates the carriage sliding mechanism to slide the blade 82 forward (an example of the predetermined traveling direction D) (see FIG. 23). The blade 82 wipes off the cleaning liquid F from the cleaning liquid supply port 13A, and then slides while wiping off the ink i from the nozzle surface 12F. Since the protruding member 91 slides in contact with the parallel surface 11P, the change in inclination angle of the blade 82 is small, and the blade 82 can be pushed against the nozzle surface 12F by a constant load. Since the blade 82 is flexible, the blade 82 is slightly bending-deformed when pushed against the nozzle surface 12F. However, since the biasing member 93 absorbs an excessive load, the blade 82 can be pushed against the nozzle surface 12F with a proper load.

When blade 82 is sliding, the ink i is diluted with the cleaning liquid F. The waste liquid W, which is a mixture of the ink i and the cleaning liquid F, flows down along the front and rear surfaces of the blade 82. The waste liquid W flowing down along the rear surface of the blade 82 passes through the through-hole 91A of the protruding member 91 and falls into the recess 81U. The waste liquid W flowing down along the front surface of the blade 82 is collected in the center in the left-and-right direction along the lower edge portion of the fixing member 94 and the lower edge portion of the protruding member 91 via the front surface of the fixing member 94, and falls into the recess 81U. The waste liquid W falling into the recess 81U passes through a discharge port (not shown) provided in the recess 81U, and falls into the cap 72.

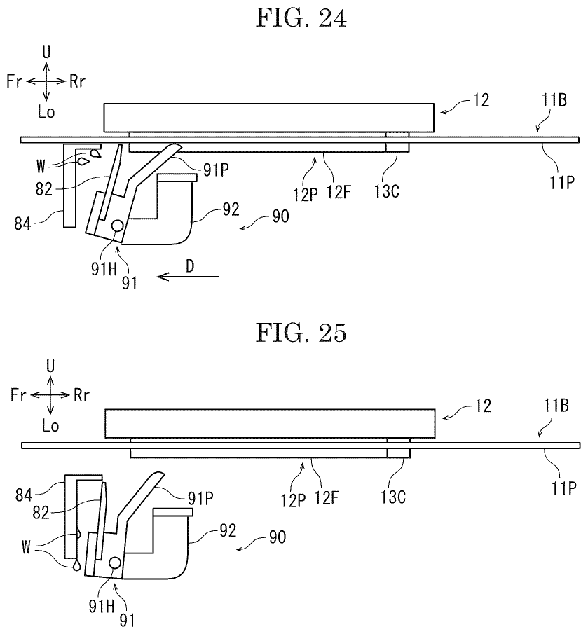

At the end of wiping, that is when the blade 82 passes through the front end portion of the nozzle surface 12F (see FIG. 24), the control part 2 operates the lifting mechanism 11L to lift the head unit 11 to the retreated position (see FIG. 19). At this time, since the head base 11B is also lifted, the protruding member 91 swings in the counterclockwise direction, and the inclination angle of the blade 82 returns to the angle α. Further, when the blade 82 is separated from the nozzle surface 12F, the bending-deformation of the blade 82 is released. By this operation, the waste liquid W is discharged from the blade 82 toward the receiving member 84. The waste liquid W received by the receiving member 84 flows downward along the inner surface of the receiving member 84, passes through the discharge port (not shown) provided in the recess 81U, and falls into the cap 72.

If a configuration (the protruding member 91, the holder 92, the biasing member 93, and the others) for changing the inclination angle of the blade 82 is not provided, the blade 82 is pushed against the nozzle surface 12F exclusively by the elastic force caused by the bending-deformation of the blade 82 itself. Therefore, when the tip end portion of the blade 82 passes through the front end portion of the nozzle surface 12F, the bending of the blade 82 is abruptly released, and the waste liquid W is discharged from the tip end portion of the blade 82 obliquely upward, and the waste liquid W may collide with the head base 11B and then scatter. On the other hand, in the present embodiment, since the blade 82 is pushed against the nozzle surface 12F mainly by the elastic force of the biasing member 93, the bending-deformation of the blade 82 is suppressed to be smaller compared with the case where the configuration for changing the inclination angle of the blade 82 is not provided. Further, since the inclination of the blade 82 is returned in parallel with the release of the bending-deformation, the waste liquid W is mainly discharged forward and received by the receiving member 84, and the scattering of the waste liquid W is suppressed.

Next, the control part 2 operates the wipe sliding mechanism 33 to house the wipe unit 80 in the housing 31 (the home position, see FIG. 17). Next, the control part 2 operates the lifting mechanism 11L to lower the head unit 11 to a height where the nozzle surface 12F is in contact with the cap 72 (see FIG. 18).

When the image forming operation is performed, the control part 2 operates the lifting mechanism 11L to lift the head unit 11 to the retracted position (see FIG. 17). Next, the control part 2 operates the cap sliding mechanism 32 to house the cap unit 70 in housing 31 (the home position, see FIG. 16), and operates the lifting mechanism 11L to lower the head unit 11 to the image forming position (see FIG. 15).

The inkjet recording apparatus 1 according to the present embodiment described above includes the blade 82 sliding in the predetermined traveling direction D along the nozzle surface 12F in the state where the tip end portion is pressed against the nozzle surface 12F of the inkjet head 12, and the receiving member 84 provided at the sliding end position of the blade 82 and receiving the waste liquid W discharged from the blade 82. According to this configuration, the scattering of the waste liquid W at the sliding end position of the blade 82 can be prevented.

According to the inkjet recording apparatus 1 according to the present embodiment, the receiving member 84 includes the front part 41 facing the blade 82 on the front side of the traveling direction D. According to this configuration, the scattering of the waste liquid W to the front side of the blade 82 can be prevented.

In addition, according to the inkjet recording apparatus 1 according to the present embodiment, the receiving member 84 includes the surrounding part 42 which surrounds at least one side of the lateral sides and the upper side of the blade 82 positioned at the sliding end position. According to this configuration, the scattering of the waste liquid W to at least one side of the lateral sides and the upper side of the blade 82 at the sliding end position can be prevented.

The inkjet recording apparatus 1 according to the present embodiment is provided with the receptacle (for example, the frame 81) which receives the waste liquid W falling from the receiving member 84. According to this configuration, the scattering of the waste liquid W falling from the receiving member 84 can be prevented.

According to the inkjet recording apparatus 1 according to the present embodiment, the lower side of the receiving member 84 is opened. According to this configuration, it is possible to prevent the waste liquid W stored in the receiving member 84 from drying and fixing to the receiving member 84.

The inkjet recording apparatus 1 according to the present embodiment includes the lifting mechanism 11L which lifts and lower the inkjet head 12 relatively to the conveyance path 10 along which the sheet S is conveyed, and the wipe sliding mechanism 33 which slides the receptacle (for example, the frame 81) to the maintenance position below the inkjet head 12 relatively lifted by the lifting mechanism 11L, and the home position on the lateral side of the maintenance position. The receiving member 84 is supported by the receptacle, and the wipe sliding mechanism 33 retracts the receptacle to the home position when performing the image forming operation.

If the receiving member 84 is provided on the side of the inkjet head 12, it is necessary to retract the receiving member 84 during the image forming operation in order to avoid interference between the receiving member 84 and the conveying unit 7. However, even if the receiving member 84 is retracted upward, the waste liquid W adhering to the receiving member 84 may fall onto the sheet S or the conveying belt 21. According to the present embodiment, since the receiving member 84 is supported by the receptacle and the receiving member 84 is retreated to the home position together with the receptacle when the image forming operation is performed, there is no risk of the waste liquid W falling on the sheet S or the conveying belt 21. It is not necessary to provide a dedicated device for retreating the receiving member 84.

1. An inkjet recording apparatus comprising:
a blade sliding in a predetermined traveling direction along a nozzle surface of an inkjet head in a state where a tip end portion is pressed against the nozzle surface, and
a receiving member provided at a sliding end position of the blade and receiving a waste liquid discharged from the blade.

2. The inkjet recording apparatus according to claim 1, wherein
the receiving member has a front part facing the blade on a front side in the traveling direction.

3. The inkjet recording apparatus according to claim 2, wherein
the receiving member has a surrounding part which surrounds at least one side of lateral sides and an upper side of the blade positioned at the sliding end position.

4. The inkjet recording apparatus according to claim 1, comprising:
a receptacle receiving the waste liquid fallen from the receiving member.

5. The inkjet recording apparatus according to claim 4, wherein
a lower side of the receiving member is opened.

6. The inkjet recording apparatus according to claim 4, comprising:
a lifting mechanism which lifts and lower the inkjet head relatively with respect to a conveyance path along which a sheet is conveyed, and
a wipe sliding mechanism which slides the receptacle to a maintenance position below the inkjet head relatively lifted by the lifting mechanism and a home position on a lateral side of the maintenance position, wherein
the receiving member is supported by the receptacle, and
the wipe sliding mechanism retracts the receptacle to the home position when an image forming operation is performed.

7. The inkjet recording apparatus according to claim 1, wherein
the blade is bending-deformed by being pressed against the nozzle surface, and
the bending deformation is released when the blade is separated from the nozzle surface at the sliding end position.

8. The inkjet recording apparatus according to claim 6, wherein
the receiving member is in contact with the inkjet head except for the nozzle surface when the receptacle is moved the maintenance position and then the inkjet head is lowered.
